(19) United States
(12) Patent Application Publication
(10) Pub. No.: US 2010/0087961 A1
(43) Pub. Date: Apr. 8, 2010

(54) HYBRID ELECTRICAL POWER SYSTEM

(75) Inventor: Thomas A. VELEZ, Huntsville, AL (US)

Correspondence Address: MCDERMOTT WILL & EMERY LLP, 18191 VON KARMAN AVE., SUITE 500, IRVINE, CA, 92612-7108, US

(73) Assignee: Lockheed Martin Corporation, Bethesda, MD (US)

(21) Appl. No.: 12/573,828

(22) Filed: Oct. 5, 2009

Related U.S. Application Data
(60) Provisional application No. 61/103,192, filed on Oct. 6, 2008.

(51) Int. Cl. G06F 1/28; G06F 1/26

(52) U.S. Cl. 700/292; 700/296; 700/295

(57) ABSTRACT

Examples of systems and methods are provided for a hybrid electrical system for supplying power to an external load. The system may include an external load bus configured to be coupled to an external load. The system may include a first bus coupled to the external load bus. The system may include a first battery coupled to the first bus. The system may include a second bus coupled to the first bus and the external load bus. The second battery may be coupled to the second bus. The second battery may have a higher extracted specific power output value than the first battery and a faster energy transfer rate than the first battery.

### CROSS-REFERENCES TO RELATED APPLICATIONS

The present application claims the benefit of priority under 35 U.S.C. §119 from U.S. Provisional Patent Application Ser. No. 61/103,192, entitled “HYBRID ELECTRICAL POWER SYSTEM,” filed on Oct. 6, 2008, which is hereby incorporated by reference in its entirety for all purposes.

### STATEMENT REGARDING FEDERALLY SPONSORED RESEARCH OR DEVELOPMENT

Not applicable.

### BACKGROUND

Several electrical power systems use batteries for providing power to an external load. Having the lightest and the smallest possible batteries to meet power requirements of an electrical load may be of importance in certain applications due to additional costs associated with weight and volume of the batteries. Battery design and selection may depend, among other things, on time variability of instantaneous electrical power requirements. For example, certain applications may require a power system that supplies relatively constant power over the duration of use (“base load”), while certain other applications may require a base load with occasional increased peak power requirements.

Rechargeable batteries may be an attractive choice in certain applications because of their re-usability. For example, rechargeable batteries are required for use in satellite launch vehicles because electrical power supply may need to be recharged prior to a re-launch if a satellite launch operation is aborted, after batteries are partially utilized. A rechargeable battery electrical power system may typically be sized to provide the peak power required, as well as the total energy required over the duration of an application. For electrical loads with numerous peaks and a much lower average power, such as rocket motor thrust vector control systems, weight of the rechargeable battery electrical power system may be predominantly determined by the peak electrical power required rather that the much lower average electrical power. For a limited time duration application, such as on satellite launch vehicles or boosters (e.g. 2-3 minutes), the unused electrical battery power corresponds to non-power producing weight, which in turn may mean additional fuel cost.

As an example, for an application where the average electrical power required is 50% of the peak load, the rechargeable battery used may be almost double in weight compared to a rechargeable battery used if the electrical load did not have any power peaks.

Rechargeable batteries may also suffer from another drawback in that rechargeable batteries may become “weaker” after a period of use and therefore may not be able to adequately meet peak power requirements towards the end of an application.

In certain aspects, a better electrical power system is needed.

### SUMMARY

These and other deficiencies of electrical power systems are addressed by configurations of the present disclosure using batteries of two different types to supply power to an electrical load. One of the batteries in the electrical power system has a higher extracted specific power than the other battery and can be discharged faster than the other battery to provide power to the electrical load. For the purposes of this disclosure, a battery's extracted specific power is considered to be that power that is extracted from the battery during the duration of use for that particular application, divided by that battery's weight (e.g., in units of Watts/kilogram). The battery can also be electrically connected or disconnected from the electrical load, as needed.

In an aspect of the disclosure, a hybrid electrical power system for supplying power to an external load may comprise one or more of the following: an external load bus configured to be coupled to an external load, a first bus coupled to the external load bus, a first battery coupled to the first bus, a second bus coupled to the first bus and the external load bus, and a second battery coupled to the second bus, wherein the second battery has a higher extracted specific power output value than the first battery and a faster energy transfer rate than the first battery.

In another aspect of the disclosure, a method of supplying power to an external load may comprise one or more of the following: coupling the external load to an external load bus, coupling a first bus to the external load bus, coupling the first battery to a first bus, coupling a second bus to the first bus and the external load bus, and coupling a second battery to the second bus, wherein the second battery has a higher extracted specific power output value than the first battery and a faster energy transfer rate than the first battery.

In yet another aspect of the disclosure, an apparatus for supplying power to an external load may comprise one or more of the following: means for coupling the external load to an external load bus, means for coupling a first bus to the external load bus, means for coupling the first battery to a first bus, means for coupling a second bus to the first bus and the external load bus, and means for coupling a second battery to the second bus, wherein the second battery has a higher extracted specific power output value than the first battery and a faster energy transfer rate than the first battery.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a chart illustrating an example of instantaneous power requirement of an electrical load as a function of time, in accordance with certain configurations of the present disclosure.

FIG. 2 is a chart illustrating power output of an electrical power system as a function of time, in accordance with certain configurations of the present disclosure.

FIG. 3 is a block diagram illustrating a hybrid electrical power system, in accordance with certain configurations of the present disclosure.

FIG. 4 is a block diagram illustrating another hybrid electrical power system, in accordance with certain configurations of the present disclosure.

FIG. 5 is a block diagram illustrating yet another hybrid electrical power system, in accordance with certain configurations of the present disclosure.

FIG. 6 is a block diagram illustrating yet another hybrid electrical power system, in accordance with certain configurations of the present disclosure.

FIG. 7A is a block diagram illustrating yet another hybrid electrical power system, in accordance with certain configurations of the present disclosure.

FIG. 7B is a block diagram illustrating yet another hybrid electrical power system, in accordance with certain configurations of the present disclosure.

FIG. 7C is a block diagram illustrating yet another hybrid electrical power system, in accordance with certain configurations of the present disclosure.

FIG. 8 is a block diagram illustrating yet another hybrid electrical power system, in accordance with certain configurations of the present disclosure.

FIG. 9 is a chart illustrating exemplary contribution of power by different types of batteries in an electrical power system, in accordance with certain configurations of the present disclosure.

FIG. 10 is a chart illustrating battery output voltages as a function of time, in accordance with certain configurations of the present disclosure.

FIG. 11A is a chart illustrating battery output currents as a function of time, in accordance with certain configurations of the present disclosure.

FIG. 11B is a chart illustrating battery output currents as a function of time, in accordance with certain configurations of the present disclosure.

FIG. 12 is a flow chart illustrating an example of a method of providing power to an external electric load, in accordance with certain configurations of the present disclosure.

FIG. 13 is a block diagram of an example of an apparatus for providing power to an external electric load, in accordance with certain configurations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

Broadly and generally, in certain aspects, a hybrid electrical power system may comprise batteries of at least two different types. Batteries of a first type may be used to supply the nominal or average power (base load) to an external electrical load requirement of an application. Batteries of the second type may be used to supply power during peak demands of the application. Batteries of the second type, supplying power during peak demands, may be characterized by a faster energy transfer rate and a higher extracted specific power output compared to batteries of the first type supplying the average power demand (e.g. 2× or 10× higher extracted specific power output). The faster energy transfer rate of a battery of the second type may be due to lower internal impedance of the battery of the second type compared to that of a battery of the first type.

Broadly and generally, in certain configurations, a hybrid electrical power system may comprise rechargeable batteries used as batteries of the first type and thermal batteries used as batteries of the second type. The rechargeable batteries may thus predominantly supply the average or nominal power requirements and the thermal batteries may predominantly supply the peak power demands. Thermal batteries may also be used to recharge the rechargeable batteries. In certain configurations, rechargeable batteries may be one of, but not limited to, a Nickel Cadmium battery, a Nickel Metal Hydride battery, a Lithium Ion battery, or a lead acid battery etc. In certain configurations, thermal batteries may comprise iron disulfide batteries or cobalt disulfide batteries.

In certain configurations, a battery of a first type (e.g., a rechargeable battery) of the power system may be designed to meet the base load requirement, plus a margin (for example, 10% additional power, or additional energy storage capacity to take into account reduction in storage capacity after multiple uses). The remaining (peak) power load may be supplied by a battery of a second type (e.g., thermal batteries). This supplemental power source (such as the thermal batteries) may have a much lower internal resistance/impedance (hence much higher internal conductivity) than the rechargeable batteries. For short durations (e.g., 2-3 minutes), the extracted power from the batteries may yield an extracted specific power a factor of ten higher for thermal batteries as compared to the rechargeable batteries. When the two power sources (rechargeable batteries and thermal batteries) are coupled in parallel, such as to a common 270 Volts direct current (VDC) bus (e.g., one or more electrical wires) to which an external load may be connected, the two batteries may be “clamped” to be at the same voltage. Because power is equal to the product of voltage and current, when a peak load is applied to the power bus (e.g., 270 VDC bus), the batteries with the lowest internal resistance/impedance (highest internal conductivity) may supply the most current.

A typical thermal battery may have a lower internal resistance compared to a typical rechargeable battery (e.g., one-quarter of the internal resistance of a typical rechargeable battery). As a result, when an electrical power system comprises rechargeable and thermal batteries, the thermal batteries may provide most of the current (hence most of the power) during peak power demand, while the energy in the rechargeable batteries may not be used during that time. The currents output by the thermal and the rechargeable batteries may be proportional to the internal resistance/impedance of the batteries. Typical thermal battery may have up to four times the conductivity of a typical rechargeable battery. Therefore, for each ampere current supplied by a rechargeable battery, four amperes may be supplied by a thermal battery when the voltages at the output of the thermal and rechargeable batteries are clamped to be identical.

As used herein, the terms “isolation” and “decoupling” may refer to substantial electrical separation between two or more electrical entities. Such a separation may not necessarily mean an “electrical open” wherein no current can flow between the electrical entities but may imply sufficient reduction in conductivity between the electrical entities to allow only a small amount (e.g., less than 100 milliamperes) of electric current flow between the electrical entities.

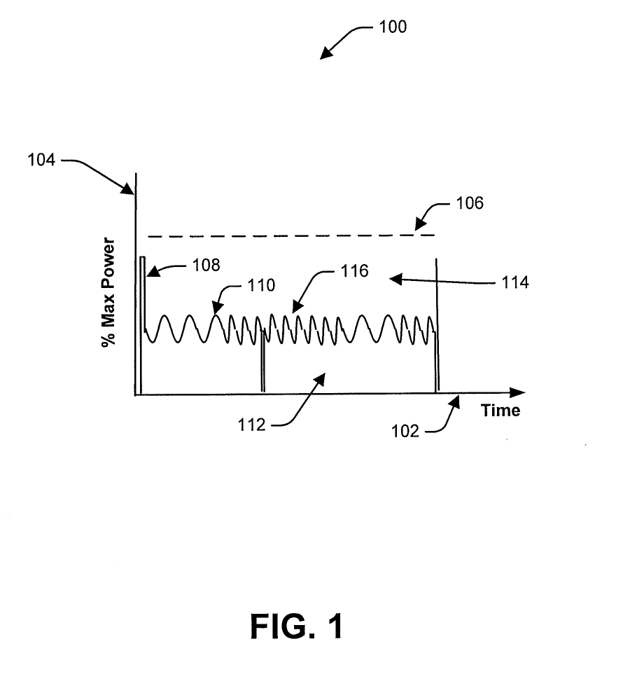

FIG. 1 is a chart 100 illustrating an example of instantaneous power requirement of an electrical load as a function of time, in accordance with certain configurations of the present disclosure. Instantaneous power requirement of an application (e.g., electrical thrust vector control system for the rocket motor of a satellite launch vehicle) as a percent of the maximum power requirement (Y-axis 104) is plotted as a function of time (X-axis 102). The instantaneous power required is depicted as curve 116, with curve 106 representing the maximum instantaneous peak power required by the application. As can be seen in FIG. 1, the instantaneous power requirements of a load may vary over time, as depicted by peak power requirements (e.g., portion 108) and fluctuations (e.g., portion 110). The area under the curve 116 may represent total energy output from the electric power system (e.g., battery) that is utilized by the load. Because instantaneous power utilization may be less than peak power utilization, the region 114 may represent unused power stored in the electrical power system, but not utilized by the load. Therefore, while a battery may be designed for supplying energy corresponding to the total area of the regions 114 and 112, the actual energy used may correspond to a smaller portion (e.g., 40 or 50%), represented by region 112. In other words, when a battery is designed to support peak power output over of an application, a large amount of battery may remain unused after utilization of the battery for the application (e.g., 50% or more battery may remain unused). Depending on the type of battery used, such a less-than-maximum utilization may come with additional costs such as having to provide more expensive, heavier batteries. In certain applications such as a satellite launch vehicle, weight of the electrical power system may be of concern because heavier batteries may require additional fuel for launching the vehicle.

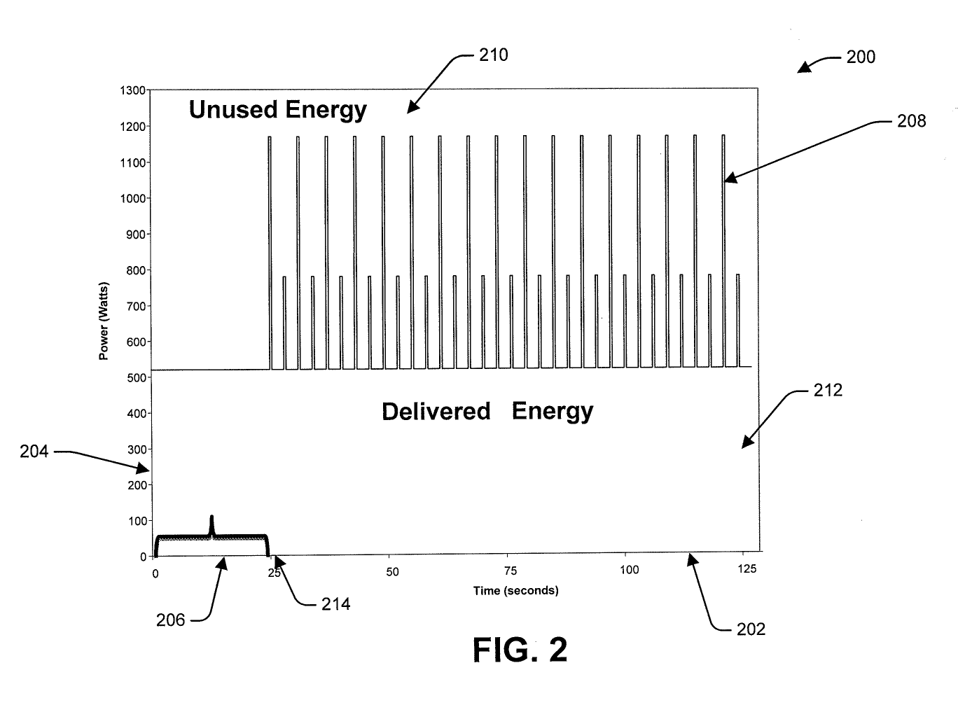

FIG. 2 is a chart 200 illustrating power output by an electrical power system as a function of time, in accordance with certain configurations of the present disclosure. The electrical power system may be operating, for example, to supply power to an application having an instantaneous power requirement as depicted in FIG. 1. Instantaneous power supplied is depicted as a curve 208, with X-axis 202 representing time in seconds and Y-axis 204 representing power supplied in watts. The power utilization depicted in chart 200 may be exhibited, for example, by an electrical power system in a satellite launch vehicle. Time period 206 may represent pre-launch time. Power output by the power system during pre-launch activities (e.g., system checks) may be relatively constant (period 206). Time 214 at the end of period 206 may represent launch time. In some cases, a satellite launch may be terminated prior to the launch time. However, some of the power stored in the electrical system may have been utilized before the termination. Therefore, it may be advantageous to supply power during the pre-launch phase from a battery that can be recharged in situ for a subsequent use (e.g., next satellite launch).

Still referring to FIG. 2, the power utilization may be characterized by a “pre-launch” phase (roughly corresponding to period 206) and a “post-launch” phase (roughly corresponding to the period after time 214). The pre-launch phase may be characterized by relatively constant power utilization. The pre-launch phase may be further characterized by possibility of termination of the application. The post-launch phase may be characterized by nominal power use interspersed with high instantaneous power demands (e.g., peak 208 that may represent two times or ten times more than nominal power). For example, in a satellite launch operations, such peak power requirements may correspond to power needed for rapid maneuvering of thruster motors.

Still referring to FIG. 2, time-variability of power utilization may influence selection of the type and the size of battery suitable for meeting the time-variable instantaneous power requirements. In FIG. 2, region 212 may represent energy delivered by a power system while region 210 may represent energy that a power system may be capable of delivering, but remains unused in the application. Furthermore, instantaneous power requirement during the one phase (e.g., pre-launch phase of a satellite launch operation) may be met using a battery that can be recharged in case of termination of the application. Additionally, the instantaneous power requirement during another phase of application (e.g., post-launch maneuvering of a satellite launch vehicle) may be met by a battery that can meet the rapid power requirement peaks and also may be able to store sufficient amount of energy to last for the entire duration of the operation. In certain aspects, it may be advantageous to release almost all energy stored in an electrical power system during the period of operation (e.g., 2-20 minutes for a satellite launch operation), leaving no or very little unused energy in the power system at the end of the application. Such a near-total drainage of power from the power system may help “right-size” the power system to an application. A right-sized power system may avoid expenses associated with a larger, heavier power system needed if not all energy in the power system can be utilized.

Accordingly, in certain aspects, configurations of the present disclosure provide hybrid electrical power systems having batteries of more than one type, electrically coupled to meet the above discussed time-variable power requirements. In certain configurations, rechargeable batteries may supply power during a phase requiring relatively constant power output (e.g., pre-launch phase of FIG. 2). However, rechargeable batteries may not be suitable for another phase (e.g., post-launch phase of FIG. 2) because rechargeable batteries may take a longer time to output stored energy. Therefore, as discussed above, rechargeable batteries may need to have significantly higher weight (e.g., four times more) than certain other types of batteries. Lighter batteries of a different battery type that can output most of their stored energy quickly may be more suitable. However, these lighter batteries may not rechargeable (e.g., thermal batteries) and therefore may not be suitable for use during the pre-launch phase of an application. As an example, thermal batteries may output their total energy in less than 90 seconds (e.g., some application may use up all energy in as little as 30 seconds).

Specifications of specific power values tested and published by the thermal battery industry and the rechargeable battery industry are not comparable. Specification of specific power and specific energy values of thermal batteries may typically take into account all packaging, support structure, terminals, etc. In contrast, specific power and specific energy specifications for rechargeable batteries may not take into account such “overheads,” but may only provide values at a cell level or even at a “theoretical” level, without all the all packaging, support structure, terminals, required thermal management system, recharging management system, and thermal management system etc. It may be possible to characterize the “extracted” specific power or power density (W/kg) in terms of the time used by an application to extract the energy. For example, for a 36 second duration, thermal batteries could have an extracted specific power of 2000 W/kg, whereas Ni-MH rechargeable batteries could have an extracted specific power of about 800 W/kg. Thermal batteries may thus typically have much higher extracted specific power compared to rechargeable batteries because of lower internal impedance (resistance), and thus much higher conductivity. In certain applications such as a satellite rocket launch operation, batteries may be used for a finite time and discarded thereafter. In such applications, extracted specific power of a battery, corresponding to total energy supplied by the battery during the lifetime of the application, may be a more relevant measure of usefulness of a battery than the specific power of the battery, corresponding to the total energy that can be “theoretically” supplied by the battery over an infinite duration.

Thermal batteries can be ramped up to output full power from no power output in a relatively small time (e.g., less than 400 milliseconds, for even large batteries weighing about 50 pounds). Therefore, a hybrid electrical power system comprising rechargeable batteries and thermal batteries may be useful in certain applications. Typically, thermal batteries are activated (initiated) by a short current application through the thermal battery's igniter (e.g., 3¼ Amps for 20 milliseconds), and the procedure for initiation of thermal batteries is well known within the art. For sake of brevity and clarity, the required ignition circuits for any thermal batteries are not specifically shown in the figures or described in the disclosure, but it is to be understood that any necessary thermal battery ignition apparatus will be inferred to be included as in normal practice of the art.

In the description below, various configurations of hybrid electrical power systems are discussed with reference to rechargeable and thermal batteries. However, one skilled in the art shall understand that the terms “rechargeable” and “thermal” are merely exemplary, and not limiting, and more broadly represent “a first type” and “a second type” of batteries having one or more characteristics described at various places in the present disclosure.

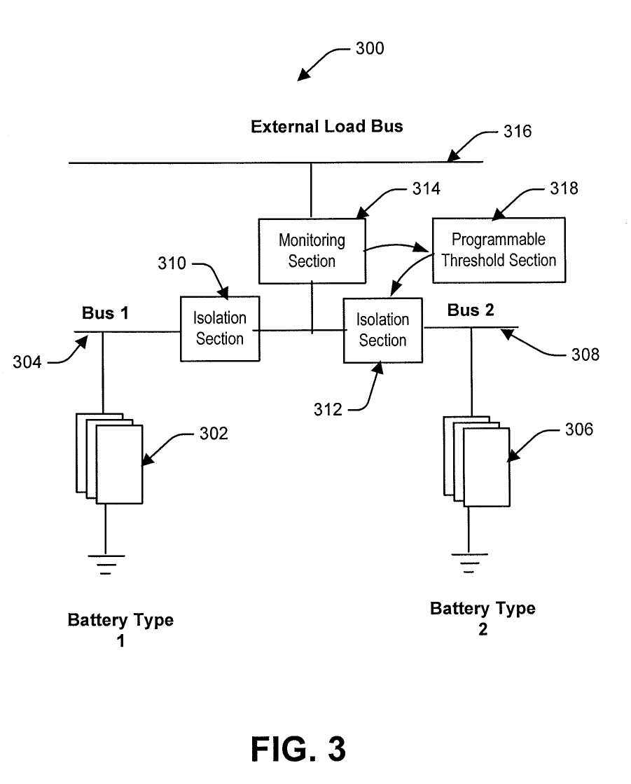

FIG. 3 is a block diagram illustrating a hybrid electrical power system 300, in accordance with certain configurations of the present disclosure. One or more batteries of a first type (e.g., rechargeable batteries) forming a first battery set 302 may be coupled to a first bus 304. One or more batteries of a second type (e.g., thermal batteries) forming a second battery set 306 may be coupled to a second bus 308. A first isolation section 310 may be provided on bus 304 to selectively isolate bus 304 and the first battery set 302, as further described below. A second isolation section 312 may be provided on bus 308 to selectively isolate bus 308 and the second battery set 306 from the external load bus 316, as further described below. Busses 304 and 308 may be coupled to an external load bus 316. The configuration depicted in FIG. 3 shows busses 304 and 308 coupled in parallel to the external load bus 316. However, one skilled in the art will recognize that busses 304 and 308 may also be coupled serially to the external load bus 316. The external load bus 316 may be provided so that an external load (not shown in FIG. 3) may be electrically coupled to the external load bus 316 and may in turn be supplied power from the first battery set 302 and/or the second battery set 306. A monitoring section 314 may be coupled to the external load bus 316 to measure certain electrical parameters (e.g., current or power transferred over the external load bus 316).

Still referring to FIG. 3, in certain configurations, isolation section 310 may be provided to selectively isolate the first battery set 302 from the external load bus 316 and batteries 306 to prevent unwanted redirection of power from the external load bus 316 and from batteries 306. For example, in certain configurations, the first battery set 302 may be comprised of rechargeable batteries and the second battery set 306 may be comprised of thermal batteries. In such configurations, isolation section 310 may prevent charging of the rechargeable batteries (first battery set 302) by the thermal batteries (second battery set 306), due to diversion of power from the thermal batteries to the rechargeable batteries instead of the external load bus 316. In certain configurations, isolation section 310 may comprise a diode. In certain configurations, isolation section 310 may comprise an electrical circuit designed to provide high impedance in one direction (from external load bus 316 to the first battery set 302) and low impedance in the opposite direction (from the first battery set 302 to external load bus 316). For example, isolation section 310 may provide higher than 1×10⁶ Ohms resistance in one direction, and may provide 75 Ohm resistance in the opposite direction. In certain configurations, the isolation section 310 may perform a switching operation. The switching operation may couple or decouple the external load bus 316 from the first battery set 302. In certain configurations, the switching may be accomplished using a circuit comprising an insulated gate bipolar transistor (IGBT). In certain configurations, isolation section 310 may have at least two states of operation: a first state in which the first battery set 302 is coupled to the external load bus 316 and a second state in which the first battery set 302 is decoupled from the external load bus 316.

Still referring to FIG. 3, isolation section 312 may be provided to selectively isolate the second battery set 306 from the first bus 304 and the external load bus 316. Isolation of the second battery set 306 may be useful to prevent dissipation of energy from the second battery set 306 during operation when the first battery set 302 may be supplying power to an external load connected to the external load bus 316. Preventing dissipation of energy from the second battery set 306 may help conserve energy stored in the second battery set 306 for use during a different phase of the power utilization. In certain configurations, isolation section 312 may comprise a diode. In certain configurations, isolation section 312 may comprise an electrical circuit having high impedance in one direction (from external load bus 316 to the second battery set 306) and low impedance in the opposite direction (from the second battery set 306 to the external load bus 316). For example, isolation section 312 may provide higher than 1×10⁶ Ohms resistance in one direction, and may provide 75 Ohm resistance in the opposite direction. In certain configurations, the isolation section 312 may perform a switching operation. The switching operation may couple or decouple the external load bus 316 from the second battery set 306. In certain configurations, the switching may be accomplished using a circuit comprising an insulated gate bipolar transistor (IGBT). In certain configurations, isolation section 312 may have at least two states of operation: a first state in which the second battery set 306 is coupled to the external load bus 316 and a second state in which the second battery set 306 is decoupled from the external load bus 316.

Still referring to FIG. 3, in certain configurations, isolation sections 310 or 312 may equalize or may intentionally provide differential voltage drops between the external load and the first bus 304 and the external load and the second bus 308. An isolation section (section 310 or 312) may achieve this equalization by acting as a switch that gradually transitions between “on” and “off” positions, causing the corresponding battery set (302 or 306) to be gradually coupled to the external load, as further described in details below.

Still referring to FIG. 3, monitoring section 314 may be configured to monitor certain electrical parameters (e.g., current or power supplied to the external load bus 316) of the electrical power system 300. Monitoring section 314 may generate signals when the monitored electrical parameters meet or exceed certain upper or lower thresholds to cause the isolation sections 310 or 312 to couple or decouple battery sets 302, 306 from the external load bus 316. In certain configurations, monitoring section 314 may comprise a current sensing circuit comprising a high input impedance solid state circuit configured to sense a current value (e.g., using the LT1495 amplifier from Linear Technology Corporation). In certain configurations, monitoring section 314 may comprise a current sensing circuit comprising a direct current (DC) current transducer using a Hall-effect open loop configuration (e.g., HAL1005 product from LEM Corporation). In certain configurations, monitoring section 314 may comprise a power sensing circuit comprising electrical components such as the MAX4210 power monitoring integrated circuit from MAXIM Corporation. In certain configurations, monitoring section may comprise a power sensing circuit comprising a current sensing circuit and a multipler to derive a power value from a current value (e.g., using CM4000HA-24H insulated gate bipolar transistor from POWEREX Corporation).

In certain configurations, a programmable threshold section 318 may provide threshold values for various electrical parameters (e.g., current or power consumption on the external load bus 316) to the isolation sections 310, 312. The thresholds may be fixed, selectable, pre-programmable or variable as determined by real-time monitoring data generated by the monitoring section 314. In certain configurations, programmable threshold section 318 may determined the thresholds based on a power utilization profile of an external electrical load. For example, for a satellite launch operation, the thresholds may be selected from one of set of thresholds depending on the type of thrust motors used on a launch vehicle, weight of the satellite, etc. In certain configurations, the thresholds may be pre-programmable using values calculated by computations performed using simulation or previous runs of the intended application of the electrical power system 300. In certain configurations, programmable threshold section 318 may be implemented as a bank of threshold sections, each threshold section corresponding to one of a set of threshold values, and a selection circuit (e.g., a programmable switch) for selecting a threshold section corresponding to the threshold used in operation. In certain configurations, a threshold section may comprise a two-input comparator circuit configured to generate a binary signal responsive to the difference between two signals at the inputs of the comparator circuit. In certain configurations, the programmable threshold section 318 may change the thresholds based on real-time data gathered. For example, in a satellite launch operation, if an on-board computer notices that the actual power utilized by an external load is different from the power utilization values used in calculation of the thresholds, the on-board computer, acting as the programmable threshold section 318, may vary the thresholds (e.g., proportionally scale the thresholds) to meet the real-time power requirements. The coupling or decoupling operations may further comprise a delay operation, as explained in greater detail below.

Still referring to FIG. 3, in certain configurations, the isolation section 312 may operate as a current limiting section to prevent the second battery set 306 (e.g., thermal batteries) from being depleted during lower power loading conditions. The isolation section 312 may decouple the second battery set 306 from the external load bus 316 whenever the current on the external load bus may be below a specified threshold value. The isolation section 312 may only couple the battery set 306 (allow current to flow) to the external load bus 316 when the load is above a specified level. This could be accomplished by solid-state circuitry. In certain configurations, the programmable threshold section 318 may provide the threshold values for the electrical parameters to the isolation section 312. The threshold values used for coupling and decoupling may be pre-specified or may be altered in real time or controlled by an operator.

Still referring to FIG. 3, in certain configurations, the monitoring section 314 may monitor an electrical value of an electrical parameter (e.g., a current or a power value) on the external load bus 316. The monitoring section 314 may communicate the monitored electrical value to an isolation section (e.g. isolation section 310 or 312). The communication between the monitoring section 314 and the isolation section 310, 312 may, for example, be in the form of an analog electrical signal or a computer message. The isolation section (e.g., isolation section 312) may be configured to decouple the corresponding battery set based on the monitored electrical value and a threshold value for the electrical parameter. The threshold value may be a lower threshold value or a higher threshold value. The decoupling may occur if the monitored electrical value is less than the lower threshold value, or the monitored electrical value is greater than the higher threshold value. Conversely, if the battery set was already decoupled from the external load bus 316, in certain configurations, coupling may occur if the monitored electrical value is greater than the lower threshold value and or if the monitored electrical value is less than the upper threshold value. In certain configurations, as described before, the threshold values may be provided to the isolation section by the programmable threshold section 318.

Based on the operational characteristics and presence or absence of various sections (e.g., isolation sections 310, 312 and monitoring section 314) several electrical power system configurations are possible consistent with the present disclosure. Table 1 lists some possible configuration options. It shall be understood by one skilled in the art that various options listed in Table 1 are merely exemplary and many other power system configurations may be possible. The first column “Option” of Table 1 lists various exemplary options. The next column “Bus Voltages” lists unloaded (i.e., when no external load is coupled to the external load bus 316) bus voltages of the first bus 304 and the second bus 308 with respect to each other. The entry “Same” corresponds to the busses 304, 308 having bus voltage values that are identical to each other (e.g., 270 VDC). The entry “bus 1>bus 2” corresponds to operating the first bus 304 at an unloaded voltage higher than the second bus 308, for reasons explained later in the present disclosure. Similarly, the entry “bus 2>bus 1” corresponds to operating the second bus 308 at an unloaded voltage higher than that of the first bus 304. The voltage difference between the higher and the lower voltage busses may, for example, be 1-10 Volts (e.g., 2 or 4 volts). The entry “optional” corresponds to operating the second bus at an unloaded voltage that is equal to, higher or lower than that of the first bus 304, as further described below. The next column “Monitoring parameter” lists the electrical parameter monitored by the monitoring section 314. The next column “Bus 1” lists sections, if any, coupled to the first bus 304. The next column “Bus 2” lists sections, if any, coupled to the second bus 308. The next column “Programmable threshold for switching” lists characteristics of whether thresholds used for switching are fixed or programmable at run-time.

TABLE 1
Examples Hybrid Electrical Power System Configurations

| | | | | | Programmable |
|---|---|---|---|---|---|
| | | Monitoring | | | threshold for |
| Option | Bus Voltages | Parameter | Bus 1 | Bus 2 | switching |
| 1A | Same | Current or | isolation | switch | Yes |
| | | power | | | |
| 1B | Same | Current | none | switch | Yes |
| 1C | Same | Power | none | switch | Yes |
| 1D | Same | Power | none | switch | Yes + delay |
| 2A | bus 1 > bus 2 | Power or | none | isolation | None |
| | | none | | | |
| 2B | bus 1 > bus 2 | Power or | none | none | None |
| | or same | none | | | |
| 2C | bus 2 > bus 1 | Power or | isolation | isolation | none |
| | | none | | | |
| 3 | Optional | Power or | switch | isolation | none |
| | | none | | or none | |
| 4 | Optional | Power or | none | none | none |
| | | none | | | |

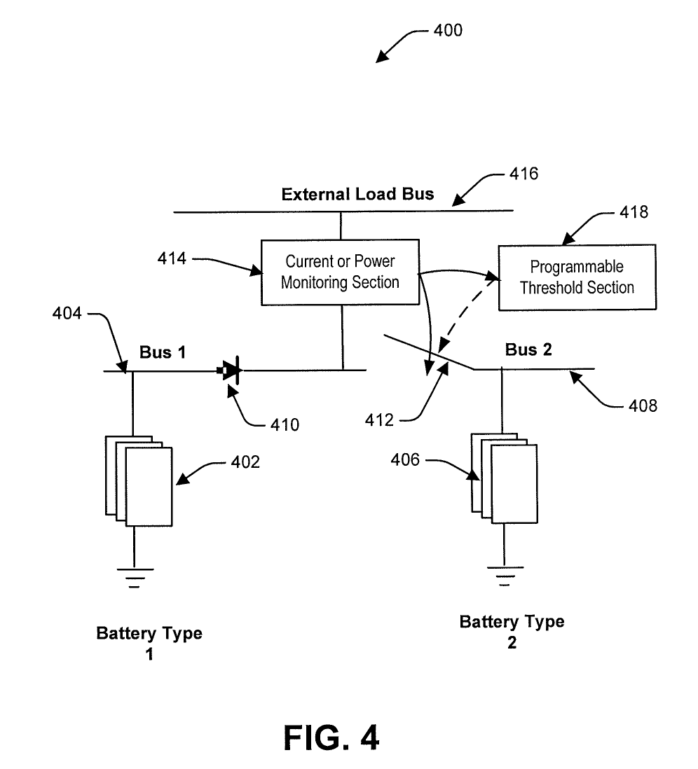

FIG. 4 is a block diagram illustrating a hybrid electrical power system 400, in accordance with certain configurations of the present disclosure. In certain aspects, hybrid electrical power system 400 may be similar to configuration Option 1A listed in Table 1. In the configuration illustrated in FIG. 4, the first battery set 402 may comprise batteries of a first type (e.g., rechargeable batteries) and the second battery set 406 may comprise batteries of a second type (e.g., thermal batteries). The first bus 404 may be coupled to the first battery set 406 and also may be coupled to a diode 410. The diode 410 may perform selective isolation of the first bus 404 from the other busses. The second bus 408 may be coupled to the second battery set 406 and may in turn by coupled to the external bus 416 and the first bus 404 through a switching section 412. The coupling/decoupling operation of the switching section 412 may be controlled by the monitoring section 414. The monitoring section 414 may monitor certain electrical parameters of the external load bus 416 (e.g., current or power utilization values). The coupling/decoupling operation of the switching section 412 may further be controlled by a programmable threshold section 418, operating similar to the programmable threshold section 318 described above.

Still referring to FIG. 4, in operation, the electrical system 400 may limit contribution to the output power by the second battery set 406 (e.g., thermal batteries), thereby conserving energy stored in the second battery set 406. For example, in certain configurations, during average battery utilization period (e.g., pre-launch phase 206 in FIG. 2), switching section 412 may be positioned to decouple the second battery set 406 from the external load bus 416 and the first bus 404. When the power demand of the external load goes higher (e.g., region 108 of FIG. 1), the monitoring section 414 may operate to position switching section 412 to couple the second battery set 406 to the external load bus 416 so that the increased power demand may be met by the second battery set 406. The monitoring section 414 may sense the increased power utilization by monitoring either current or power utilization on the external load bus 416. The diode 410 may prevent recharging of the first battery set 402 by preventing current flowing in a reverse direction on the first bus 404. In certain configurations, the switching section 412 may be operated by delaying coupling/decoupling by certain time period (e.g., 8-50 milliseconds) after the monitoring section 414 has sensed an electrical parameter (e.g., current or power) exceeding certain thresholds, to prevent “chattering.” or rapid coupling/decoupling of the second bus 408. Chattering may refer to unwanted rapid coupling/decoupling of the second battery set 406 with the external load bus 416 that may be caused to do switching in response to transient changes in the monitored electrical values (e.g., current or power) on the external load bus 416. In certain configurations, the switching section 412 may be configured to delay the coupling/decoupling operations by about 8 to 50 milliseconds (e.g., 8 milliseconds or 20 milliseconds) after a monitored value exceeds (or falls below) a corresponding threshold value. In certain configurations, the switching section 412 may be configured to suppress transient surges (“spikes”) in instantaneous current or power consumption values due to switching. The spike suppression may be achieved by providing a ramp up or a ramp down transition period in which the current (or power) on the bus gradually changes from one value (e.g., value in the coupled state) to another (e.g., value in the decoupled state) during coupling (or decoupling) operation. By way of example, the ramp up or ramp down transition period may be between 8 to 50 milliseconds.

Still referring to FIG. 4, in certain configurations, operation of switching section 412 may include at least two threshold values for each monitored parameter. A first threshold value may be used to operate switching section 412 to couple the second battery set 406 to external load bus 416. A second threshold value may be used to operate switching section 412 to decouple the second battery set 406 from external load bus 416. Depending on the electrical parameter monitored, the threshold may correspond to an upper limit or a lower limit for the monitored parameter, beyond which the coupling/decoupling operation may be performed. For example, when power is monitored on the external load bus 416, coupling may be performed if the monitored power value goes above a certain threshold. Furthermore, when the monitored power value falls below a certain threshold, the second battery set 406 may be decoupled from the external load bus 416. The coupling/decoupling operation may thus allow the second battery set 406 to supply power when power utilization by an external load goes higher than the first threshold, and may turn off supply of power from the second battery set 406 when power utilized by the external load falls below the second threshold.

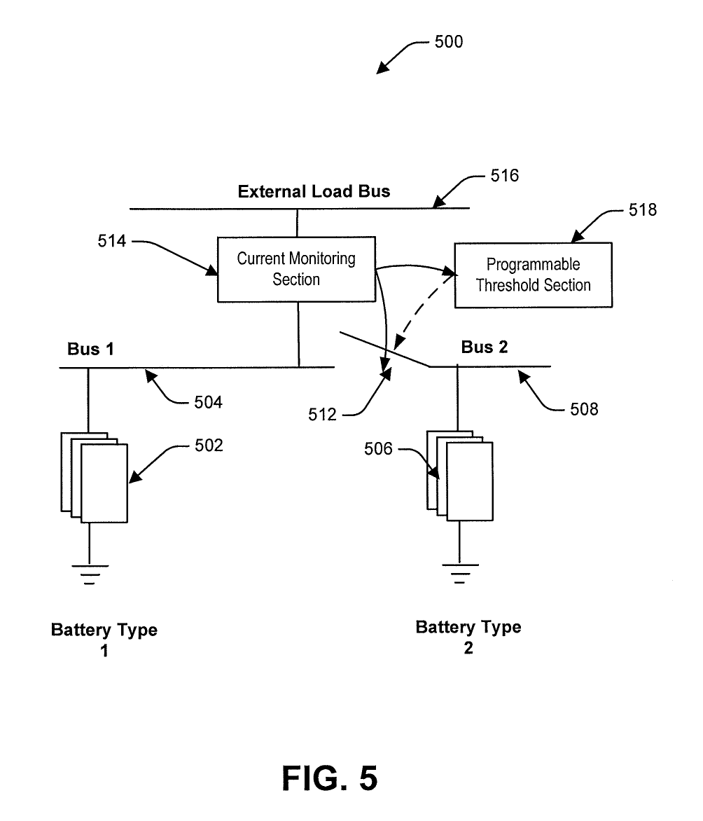

FIG. 5 is a block diagram illustrating another hybrid electrical power system 500, in accordance with certain configurations of the present disclosure. In certain aspects, hybrid electrical power system 500 may be similar to configuration Option 1B listed in Table 1. In the configuration illustrated in FIG. 5, the first battery set 502 may comprise rechargeable batteries and the second battery set 506 may comprise thermal batteries. The first bus 504 may be coupled to the first battery set 502. The second bus 508 may be coupled to the second battery set 506 and may in turn by coupled to the external bus 516 and the first bus 504 through a switching section 512. The coupling/decoupling operation of the switching section 512 may be controlled by the current monitoring section 514. The current monitoring section 514 may monitor a current value on the external load bus 516. The coupling/decoupling operation of the switching section 512 may further be controlled by a programmable threshold section 518 operating similar to the programmable threshold section 318 described above.

Still referring to FIG. 5, in operation, the electrical system 500 may limit contribution to the output power by the second battery set 506 (e.g., thermal batteries), thereby conserving energy stored in the second battery set 506 during periods of nominal power use. For example, in certain configurations, during average battery utilization period (e.g., pre-launch phase 206 in FIG. 2), the switching section 512 may decouple the second battery set 506 from the external load bus 516 and the first bus 504. When the power demand of the external load goes higher (e.g., region 108 of FIG. 1), the current value monitored by the current monitoring section 514 may increase above a current threshold value. The current threshold value may be programmable by the programmable threshold section 518. In certain configurations, the current threshold value may be pre-determined (e.g., by offline analysis of electrical characteristics of the external load). In certain configurations, the current threshold value may be determined at run-time (e.g., based on a previously observed peak current value). When the current value goes above the current threshold value, the current monitoring section 514 may cause the switching section 512 to operate to couple the second battery bus 508 to the external load bus 516 so that the increased power demand may be met by the second battery set 506. In certain configurations, the switching section 512 may be operated by delaying coupling/decoupling by certain time period (e.g., 10-50 milliseconds) to prevent “chattering” or rapid coupling/decoupling of the second bus 508 when the current value on the external load bus 516 is in the vicinity of the current threshold value.

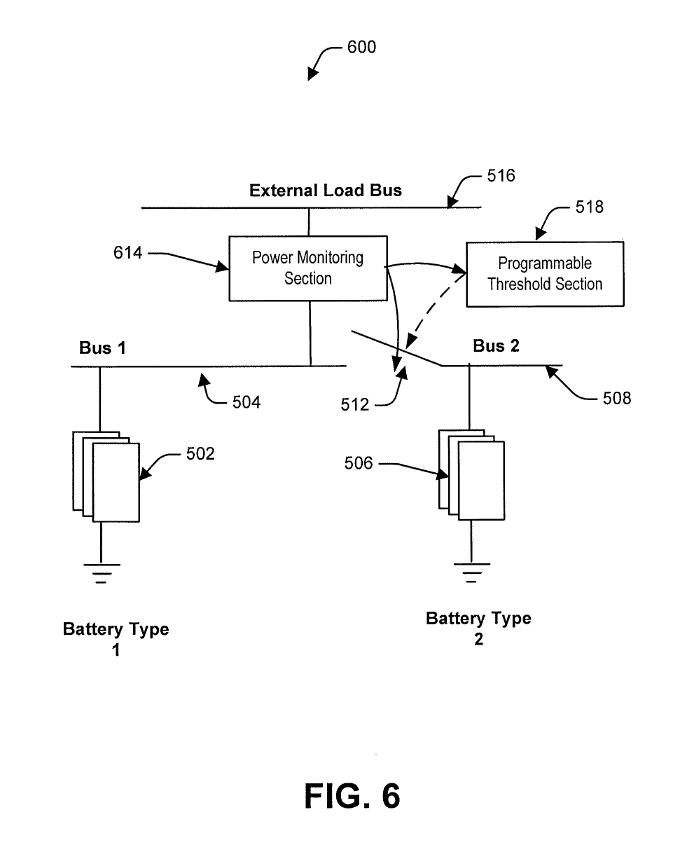

FIG. 6 is a block diagram illustrating yet another hybrid electrical power system 600, in accordance with certain configurations of the present disclosure. In certain aspects, hybrid electrical power system 600 may be similar to configuration Option 1C listed in Table 1. Operation of the electrical power system 600 may be explained with reference to operation of the electrical power system 500 depicted in FIG. 5. With reference to the electrical power system 500, like-numbered elements of FIG. 6 may perform identical functions. The operation of switching section 512 in the electrical power system 600 may be controlled by monitoring power supplied to the external load bus 516 in a power monitoring section 614. During operation, when power utilization by an external load (not shown in FIG. 6) coupled to the external load bus 516 goes higher than a power threshold value, the power monitoring section 614 may generate a signal and/or cause the switching section 512 to operate to couple the second battery set 506 to the external load bus 516. When coupled to the external load bus 516, the second battery set 506 may provide power to the additional power utilization by the external load. When the power utilization monitored by the power monitoring section 614 falls below a second power threshold, the power monitoring section 614 may cause the switching section 512 to operate to decouple the second battery set 506 from the external load bus 516. De-coupling the second battery set 506 from the external load bus 516 may result in the first battery set 502 being the predominant (or only) suppliers of power for the reduced power demand. In certain configurations, switching section 512 may additionally be operated using a programmable power threshold, similar to the operation described with respect to the programmable threshold section 518 in FIG. 5. In certain configurations, switching section 512 may be additionally be operated using a time delay section (not shown in FIG. 6). The operation of the time delay section may be similar to the time delay operation described with respect to FIG. 4.

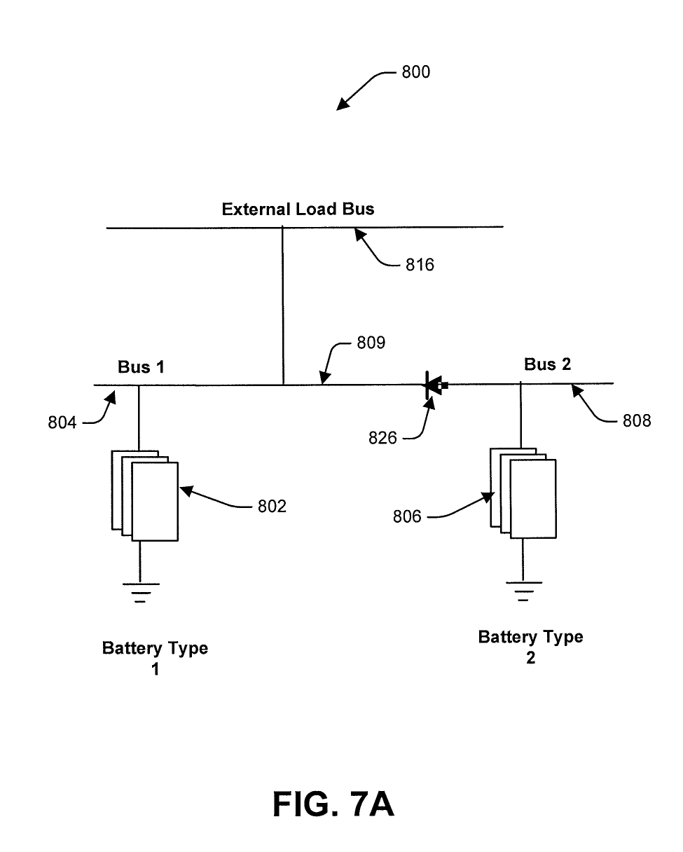

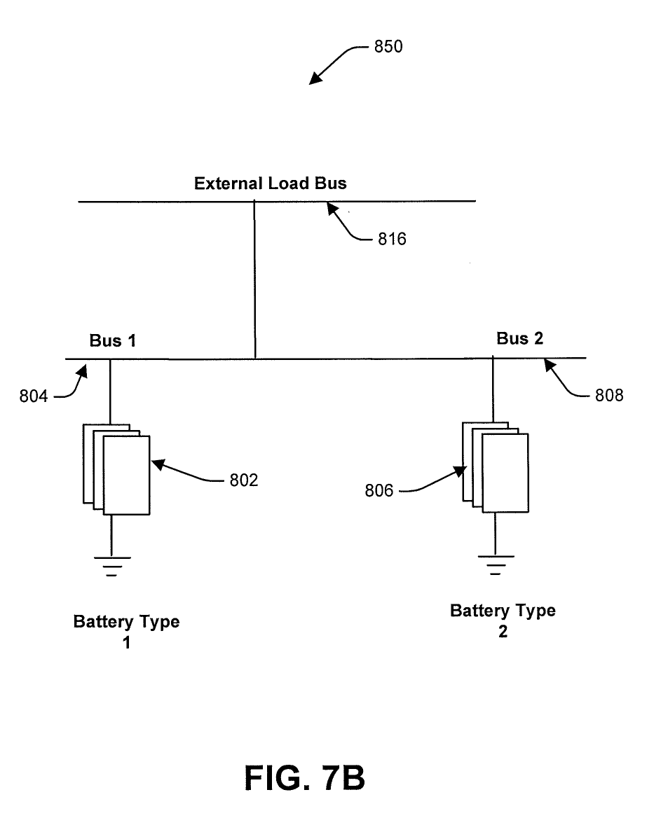

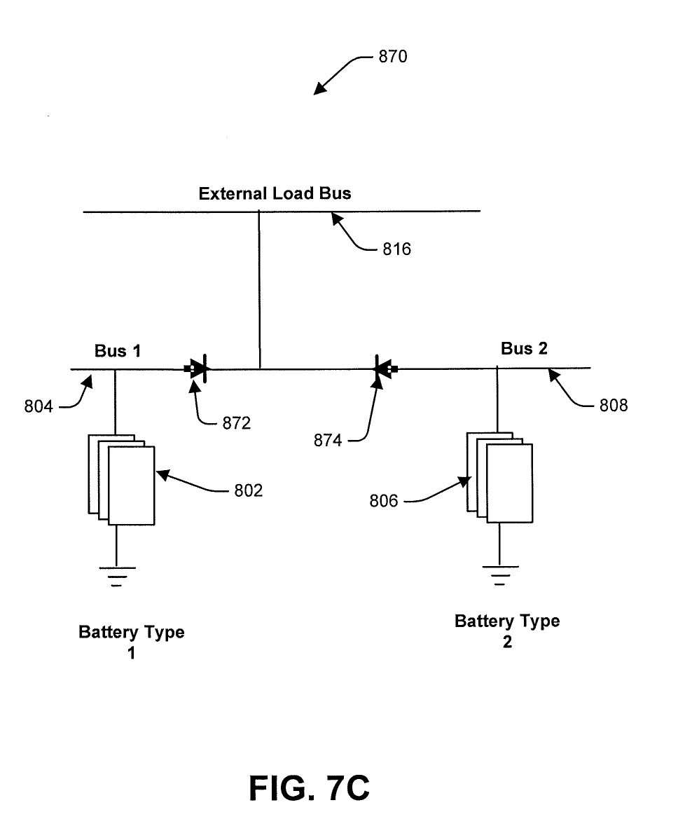

FIG. 7A is a block diagram illustrating a hybrid electrical power system 800, in accordance with certain configurations of the present disclosure. In certain aspects, hybrid electrical power system 800 may be similar to configuration Option 2A listed in Table 1. The first battery set 802 (e.g., rechargeable batteries) is coupled to a first bus 804 and a second battery set 806 (e.g., thermal batteries) are coupled to a second bus 808. Busses 804 and 808 may be coupled to each other via an isolation section 826. The first bus 804 may be operated at an unloaded voltage higher than that of the second bus 808 (e.g., higher by 1 to 10 Volts). Because voltage on the first bus 804 is higher than voltage on the second bus 808, the isolation section 826 may be biased to decouple the second battery set 806 from the external load bus 816. For example, when the isolation section 826 comprises a diode, as depicted in FIG. 7A, the voltage difference between busses 804 and 808 may bias diode 826 so that current may not flow from bus 808 to the section 809, coupled to the external load bus 816. When the external load (not shown in FIG. 7A) is at a nominal value (e.g., pre-launch phase 206), the first battery set 802 may predominantly supply power to the external load, because the second battery set 806 may be decoupled from the external load bus 816.

Still referring to FIG. 7A, as the power utilization of the external load goes higher (e.g., during maneuvering in the post-launch phase in FIG. 2), the bus voltage on the first bus 804 may drop due to the increased loading or due to weakening of batteries in the second battery set 802 due to discharge of energy. When the voltage on the first bus 804 drops to a sufficiently low value (e.g., one volt below nominal bus value of 270 volts), the isolation section 826 may couple the second bus 808 to the section 809, and in turn to the external load bus 816. For example, when the isolation section 826 comprises a diode, the diode may “turn on” when the voltage difference between first bus 804 voltage side and the second bus 808 voltage side of the diode falls below a biasing voltage value for the diode. When the isolation section 826 operates to couple the second bus 808 to the external load bus 816, contribution by the second battery set 806 to the power utilized by the external load may become significant. In certain configurations, due to lower internal impedance of the batteries of the second battery set 806, the power to the external load may be entirely contributed by the second battery set 806. Therefore, for example, the second battery set 806 may provide most of the power during peak power requirements by an external load bus (e.g., at peak 208 of FIG. 2). Note that while the illustrated embodiment in FIG. 7A does not show a current or power monitoring section, Certain configurations may be operated without such a monitoring section because the two busses (bus 804 and bus 808) are coupled to each other and contribution of power from each battery set is therefore controlled by voltages on the busses 804 and 808.

FIG. 7B is a block diagram illustrating a hybrid electrical power system 850, in accordance with certain configurations of the present disclosure. In certain aspects, hybrid electrical power system 850 may be similar to configuration Option 2B listed in Table 1. In the illustrated configuration, no isolation sections are provided on either bus 804 or bus 808. In certain configurations, if the unloaded voltage of the first bus 804 and the second bus 808 are equal, because of higher internal conductivity, the second battery set 806 (e.g., thermal batteries) may initially contribute greater load sharing power to the external load until the second battery set 806 has expended energy and voltage at the output of the second battery set 806 drops. When the second battery set 806 gets partially discharged during use, the first battery set 802 begins to contribute more power to the external load bus 816. Such configurations, as depicted in FIG. 7B, may be useful in applications that require more power and energy from the second battery set 806 (e.g., thermal batteries) first. For example, in certain applications, the second battery set 806 may initially be required to “warm up” the electronics (e.g., before launch of a rocket from the surface of the moon or another planet after extended “cold soaking”) and recharge the first battery set 802 (e.g., a rechargeable battery) before using the first battery set 802.

Still referring to FIG. 7B, if the first bus 804 has a higher initial voltage than the second bus 808 (e.g., 2 volts or 5 volts higher), then the first battery set 802 and the first bus 804 will output more power initially than otherwise, and even more than the second bus 2 and second battery set 806. Thus, by adjusting the initial voltage differential (e.g., by selecting or designing batteries with the desired initial unloaded voltage values) between the first bus 804 and the second bus 808, it may be possible to make design adjustments to tailor the power sharing, energy sharing, and timing of the contribution of each bus as to percentage of power provided instantaneously to the load bus 816, timing of power application and ramp-up of power, and the total energy contributed by each bus and battery set.

FIG. 7C is a block diagram illustrating a hybrid electrical power system 870, in accordance with certain configurations of the present disclosure. In certain aspects, hybrid electrical power system 850 may be similar to configuration Option 2C listed in Table 1. In the illustrated configuration, a diode 872 is provided as the isolation section on the first bus 804 and a diode 874 is provided as the isolation section on the second bus 808. The operation of diodes 872, 874 may be similar to the operation of diode 410 and operation of diodes described with respect to FIG. 3 and FIG. 7A.

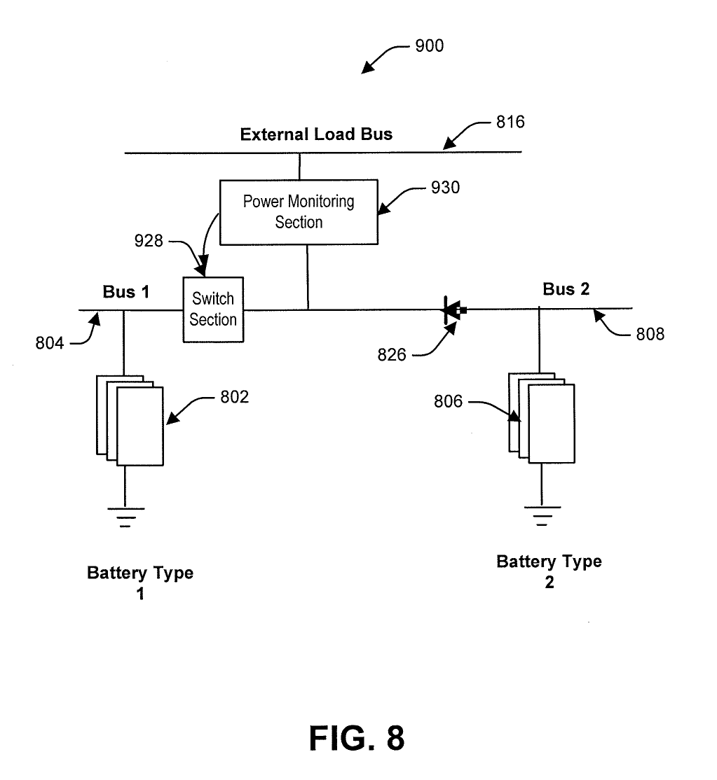

FIG. 8 is a block diagram illustrating a hybrid electrical power system 900, in accordance with certain configurations of the present disclosure. In certain aspects, hybrid electrical power system 900 may be similar to configuration Option 3 listed in Table 1. Operation of the electrical power system 900 may be explained with reference to operation of the electrical power system 800 depicted in FIG. 7A. In the hybrid electrical power system 900, the first bus 804 may be operated at an unloaded voltage higher than that of the second bus 808. With reference to the electrical power system 800, like-numbered elements of FIG. 8 may perform identical functions. Furthermore, the switching section 928 may be configured to perform switching operations described previously with respect to element 512. Similarly, operation of power monitoring section 930 may be similar to the power monitoring section 614 described previously with respect to FIG. 6.

Referring to the configurations in FIGS. 7A, 7B, 7C and 8, in certain configurations (e.g., option 2C listed in Table 1), the second bus 808 (e.g., a bus coupled to thermal batteries) may be operated at a higher voltage than the first bus 804 (e.g., a bus coupled to rechargeable batteries). For example, the second bus 808 may be operated at a voltage that is about 1-10 volts more than that of the first bus 804. In such configurations, an isolation section may be provided on the first bus 804 to prevent the second battery set 806 from recharging the first battery set 802.

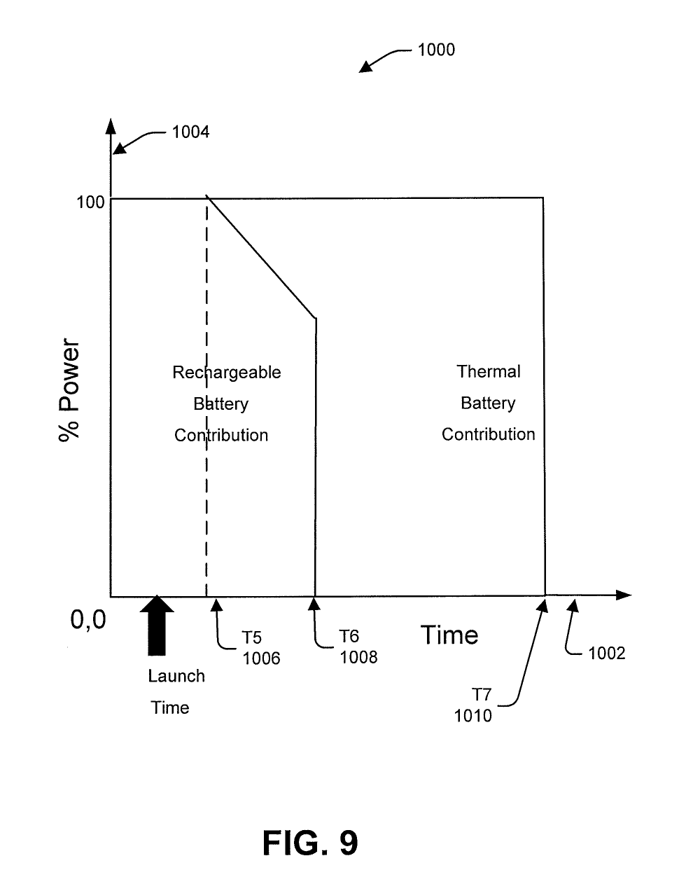

FIG. 9 is a chart 1000 illustrating an example of contribution of power by different battery sources in an electrical power system, in accordance with certain configurations of the present disclosure. In certain aspects, power contributions depicted in FIG. 9 may be exhibited by an electrical power system configuration similar to the Option 4, listed in Table 1. This is also exactly the same configuration as Option 2B, listed in Table 1, and illustrated in FIG. 7B, but with the batteries of the first and the second battery set resized to operate in a completely different manner. In the configuration illustrated in FIG. 7B, the batteries may be resized such that the first battery set 802 (e.g., rechargeable batteries) may be sized to handle both the peak loads and total energy (plus a margin for smooth transition of power sharing) needed prior to a later initiation of the second battery set 806 (e.g., thermal batteries). The activation of the second battery set (806) may take place after the final commit to continue (such as after the latest abort opportunity in the launch of a satellite launch vehicle). In certain configurations, the first battery set 802 may handle supplying power to all the pre-commit testing, and still be capable of an abort, followed by subsequent recharging and reuse. The second battery set 806 may be sized appropriately to provide the remaining required power and energy to the external load bus 816. After onset of an application and passage of a period of time, the second battery set 806 may be activated to begin supplying power to the external load (e.g., by initiation of a thermal battery). During the initial period of time, power to the external load may be supplied only by the first battery set 802. In certain configurations, the second bus 808 may be configured to operate at an unloaded voltage equal to that of the first battery bus 804. The equal unloaded voltages may facilitate progressive increase in contribution to power by the second battery set 806 once the second battery set 806 is activated and begins supplying power to the external load.

Still referring to FIG. 9, in chart 1000, Y-axis 1004 may represent percent power contribution and X-axis 1002 may represent time. From the beginning of the application at time 0 until time T5 1006, all power to the external load may be contributed by the first battery set (e.g., rechargeable batteries). Between times T5 1006 and T6 1008, the power contribution by the first battery set decreases, with power contribution from the second battery set increasing over the same duration. The decreased contribution may be a result of exhaustion of energy stored in the first battery set. During this transition period between T5 1006 and T6 1008, energy stored in the first battery set may be depleted, and may result in reduced ability of the first battery set to maintain voltage of the first bus at a high value (e.g., 270 volts). The drooping of the voltage value on the first bus may increase with time, due to continued depletion of energy from the first battery set, eventually leading the first battery set being completely cut off at time T6 1008 and all power contribution thereafter may be by the second battery set. The application may terminate at time T7 1010.

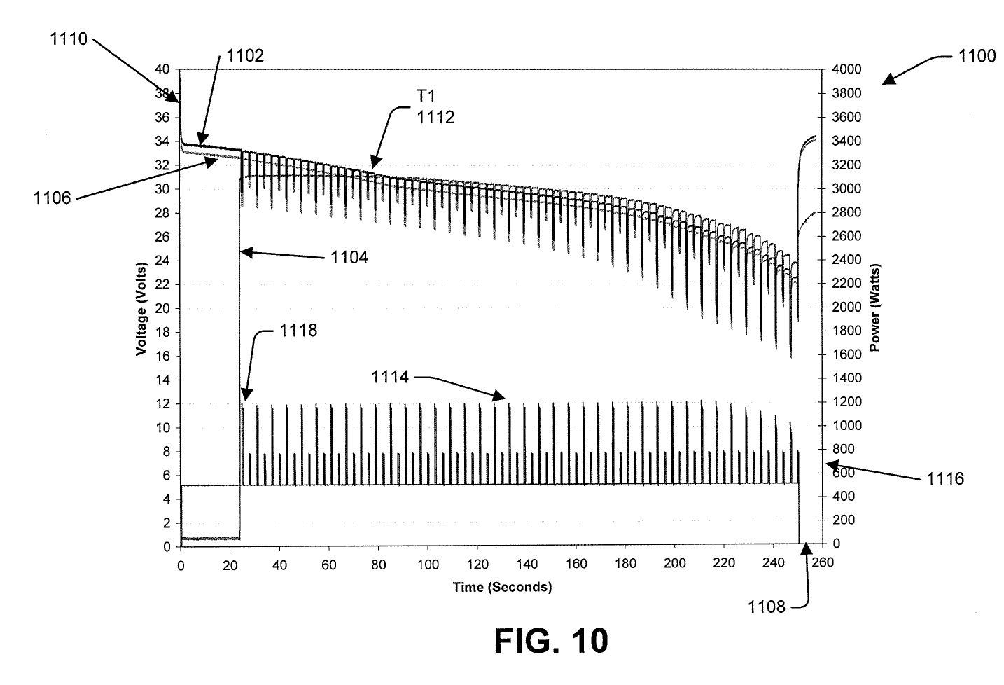

FIG. 10 is a chart 1100 illustrating output voltages as a function of time, in accordance with certain configurations of the present disclosure. Values of voltage output of the first battery set (curve 1102) and voltage output of the second battery set (curve 1104) and voltage of the external load bus (curve 1106) are plotted as a function of time (axis 1108), with Y-axis 1110 representing voltage in Volts. Curve 1114 may represent instantaneous power utilized by the external load, in units of watts, indicated along the axis 1116. In the depicted example, from the start of the application (i.e., start of power utilization by an external load) until time T1 1112, output voltage of the first battery set may be higher than the output voltage of the second battery set, resulting in the power contribution to the external load predominantly from the first battery set. After the first power spike 1118, the second battery set may begin power contribution to support the instantaneous increased power requirement. After time T1 1112, voltage at the output of the first battery set may have dropped sufficiently low, reducing power contribution of the first battery set, and power to the external electric load may be predominantly provided by the second battery set.

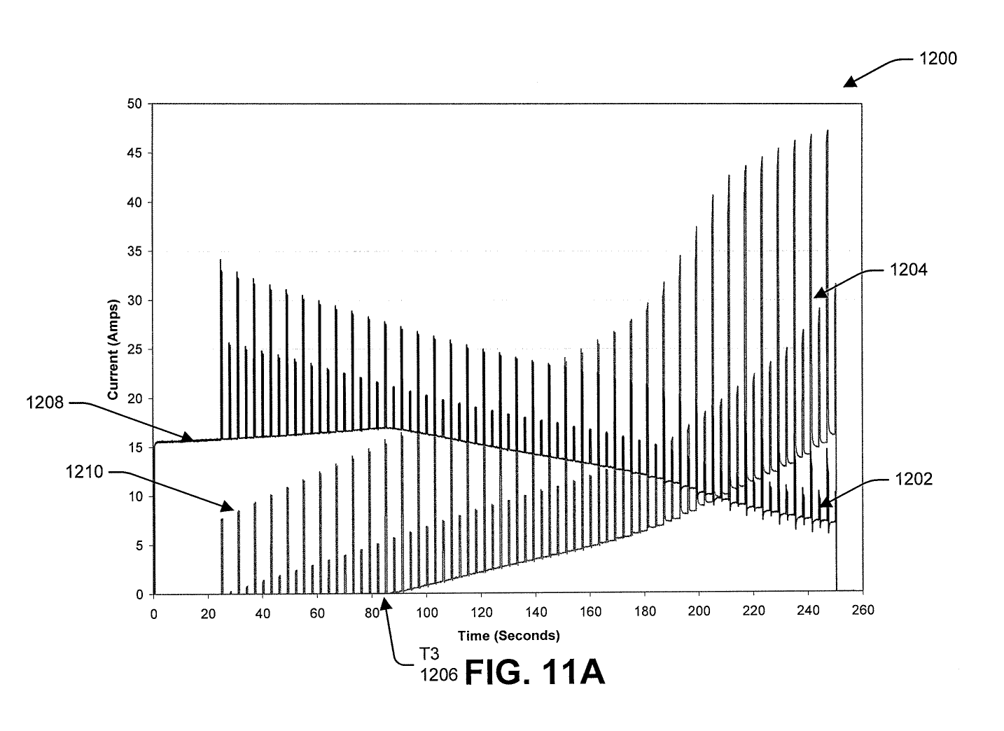

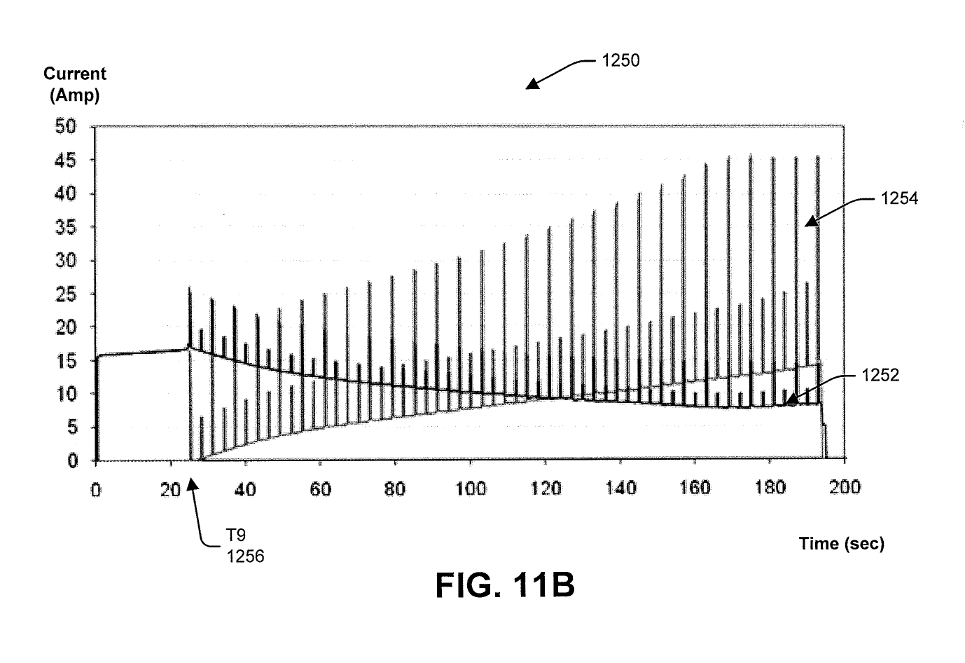

FIG. 11A is a chart 1200 illustrating output currents in an electrical power system as a function of time, in accordance with certain configurations of the present disclosure. The current output of a first battery set is depicted as curve 1202 and the current output of a second battery set is depicted as curve 1204. From the beginning of an application until time T3 1206 (roughly corresponding to time T1 1112 in FIG. 10), the first battery set may provide most of the power used by the external load. In certain configurations, current output of the first battery set may increase slightly until time T3 1206 to compensate for voltage droop due to depletion of energy from the first battery set. Until time T3 1206, current output 1204 of the second battery set may be relatively small compared to the current output 1202 (e.g., less than 10%), with peaks in the current output 1204 coinciding with power requirement spikes (e.g., as shown in FIG. 2). Until time T3 1206 (e.g. portion 1208 of curve 1202) the base power to the external load is initially supplied by the first battery set and, occasional peak power (e.g., 1210) may be supplied by the second battery set. After time T3 1206, the average voltage output of the first battery set may fall below the voltage output of the second battery set, as indicated by the droop in the lower envelope of curve 1202. The second battery set may begin contributing significantly more to the power utilized by the external load, both for the base load and for the occasional peak power requirements. Therefore, current output 1204 of the second battery set may increase beyond time T3 1206, and current output 1202 of the first battery set may go down over the same time interval.

FIG. 11B is a chart 1250 illustrating output current in an electrical power system as a function of time, in accordance with certain configurations of the present disclosure. The current output of the first battery set is depicted as curve 1252 and the current output of the second battery set is depicted as curve 1254. The output current characteristics depicted in FIG. 11B may be exhibited by, for example, configuration option 2B wherein bus 1 is operated at a voltage higher than that of bus 2 (e.g., by 5 volts). As depicted in FIG. 11B, because the second battery set is configured to operate at a lower unloaded voltage, the second battery set is effectively turned off initially, and all contribution to the output current is from the first battery set, as shown by curve 1252. After passage of some amount of time, during which the first battery set discharges its stored energy and the voltage at the output of the first battery set drops, the second battery set turns on and begins contributing to the output power (e.g., starting at time T9 1256). During the remaining time in the application, current contribution from the second battery set progressively increases, while current contribution from the first battery set progressively reduces due to reduction in the stored energy in the first battery set.

It will be appreciated that certain configurations of the present disclosure provide electrical power systems that may comprise at least two different types of batteries. While various configurations illustrated in FIGS. 2 to 9 depict electrical power systems having two battery busses, configurations that use more than two battery busses or more than two types of batteries may be possible. In such configurations, each battery bus may have associated monitoring, isolation and programmable threshold sections and selective isolation and switching of different battery types may be achieved commensurate with power utilization of external electric load.

In certain configurations, rechargeable batteries and thermal batteries may be coupled in series or in parallel to supply power to an external load. In certain configurations, rechargeable batteries may supply power to an external load at the onset of an application. After a period of time, thermal batteries may be initiated and brought online to supply power to spikes in power required by the external load. In one aspect, configurations of the present disclosure may enable sizing the rechargeable batteries and the thermal batteries to a lowest possible size to meet the power requirements of the application. In certain configurations, the savings in size may translate in savings in weight and consequently savings in fuels need to launch a rocket carrying the batteries.

In certain configurations, using thermal batteries enables deployment of the electrical power systems harsh environments due to relative robustness of thermal batteries to temperature, shocks and vibrations. Because certain configurations utilizing both thermal (or other primary) batteries and rechargeable batteries may reduce total power system weight, engineering tradeoffs may be possible to enable selection of more robust rechargeable batteries (technologies or chemistries) which might have less extracted specific power capabilities, but may still meet or reduce the total power system weight compared to using only rechargeable batteries for the power system. In certain aspects, thermal batteries may provide long maintenance free, shelf-life (e.g. 10-20 years).

In certain configurations, using rechargeable batteries during initial time period may allow simplified preparation of the electrical system for a subsequent application by recharging the batteries, if an application is terminated during the initial time period. The power to recharge the rechargeable batteries may be provided from ground power, thermal batteries or other vehicle power.

In certain aspects, configurations of the present disclosure may allow “optimal” utilization of thermal batteries in the sense of not initiating the thermal batteries for use until after time for the last available application termination opportunity has passed. Thermal batteries may be brought online thereafter and may be able to supply full power in a relatively short time period due to rapid internal heating by pyrotechnics to fully operational temperature (e.g., in 200 milliseconds).

The subject technology is illustrated, for example, according to various aspects described below. Numbered clauses are provided below for convenience. These are provided as examples, and do not limit the subject technology.

1. A hybrid electrical power system for supplying power to an external load, comprising:

an external load bus configured to be coupled to an external load;

a first bus coupled to the external load bus;

a first battery coupled to the first bus;

a second bus coupled to the first bus and the external load bus; and

a second battery coupled to the second bus;

wherein the second battery has a higher extracted specific power output value than the first battery and a faster energy transfer rate than the first battery.

2. The hybrid electrical power system of clause 1, wherein

the second bus is isolatably coupled to the first bus and the external load bus by a first isolation section.

3. The hybrid electrical power system of clause 2, wherein:

the first bus is isolatably coupled to the second bus and the external load bus by a second isolation section.

4. The hybrid electrical power system of clause 2, wherein:

the first bus and the second bus are configured to operate at an identical unloaded voltage.

5. The hybrid electrical power system of clause 2, wherein:

the first isolation section is configured to prevent charging of one of the first and the second batteries by the other one of the first and the second batteries.

6. The hybrid electrical power system of clause 2, wherein:

the first isolation section comprises a diode.

7. The hybrid electrical power system of clause 2, wherein:

the first battery comprises a rechargeable battery.

8. The hybrid electrical power system of clause 2, wherein:

the second battery comprises a thermal battery.

9. The hybrid electrical power system of clause 2, wherein:

the first bus is operated at an unloaded voltage lower than an unloaded voltage of the second bus.

10. The hybrid electrical power system of clause 2, wherein:

the second bus is configured to operate at an unloaded voltage lower than an unloaded voltage of the first bus.

11. The hybrid electrical power system of clause 2, further comprising:

a monitoring section configured to monitor an electrical value of an electrical parameter on the external load bus,

wherein the first isolation section configured to decouple the second battery from the external load bus responsive to the monitored electrical value and a threshold value of the electrical parameter.

12. The hybrid electrical power system of clause 11, further comprising:

a programmable threshold section configured to provide the threshold value of the electrical parameter to the first isolation section.

13. The hybrid electrical power system of clause 11, wherein:

the electrical value comprises a current value on the external load bus; and

the threshold value comprises a first current threshold value.

14. The hybrid electrical power system of clause 11 wherein:

the first isolation section comprises an insulated gate bipolar transistor (IGBT).

15. The hybrid electrical power system of clause 11, wherein:

the electrical value comprises a power value on the external load bus;

the threshold value comprises a first power threshold value.

16. The hybrid electrical power system of clause 11, wherein:

the first isolation section is configured to couple or decouple using a time-delayed operation.

17. The hybrid electrical power system of clause 1, wherein:

the first bus is isolatably coupled to the second bus and the external load bus by an isolation section.

18. The hybrid electrical power system of clause 17, further comprising:

a monitoring section configured to monitor an electrical value of an electrical parameter on the external load bus,

wherein the isolation section is configured to decouple or couple the first battery from the external load bus responsive to the monitored electrical value and a threshold value of the electrical parameter.

The subject technology is illustrated, for example, according to various aspects described below. Numbered clauses are provided below for convenience. These are provided as examples, and do not limit the subject technology.

1. A method of supplying power to an external load, comprising:

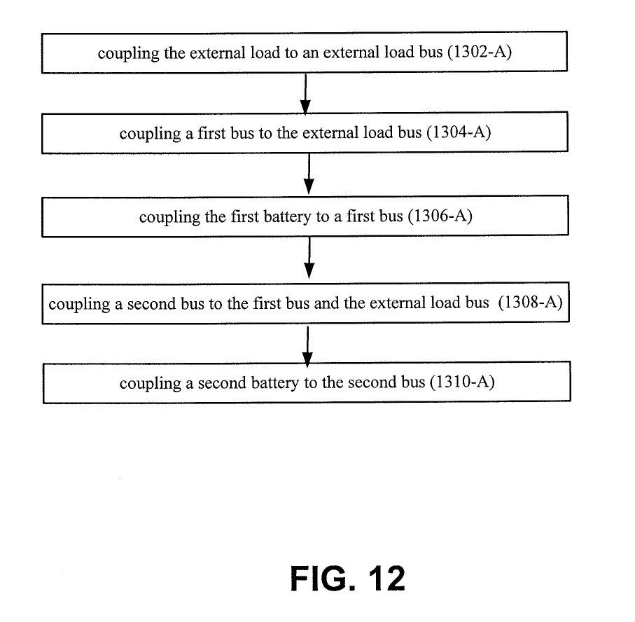

coupling the external load to an external load bus (e.g., 1302-A of FIG. 12);

coupling a first bus to the external load bus (e.g., 1304-A of FIG. 12);

coupling the first battery to a first bus (e.g., 1306-A of FIG. 12);

coupling a second bus to the first bus and the external load bus (e.g., 1308-A of FIG. 12); and

coupling a second battery to the second bus (e.g., 1310-A of FIG. 12);

wherein the second battery has a higher extracted specific power output value than the first battery and a faster energy transfer rate than the first battery.

2. The method of clause 1, wherein:

the coupling the second bus comprises coupling, isolatably, the second bus to the first bus and the external load bus by a first isolation section

3. The method of clause 2, further comprising:

coupling, isolatably, the first bus to the second bus and the external load bus by a second isolation section.

4. The method of clause 2, further comprising:

operating the first bus and the second bus at identical unloaded voltage.

5. The method of clause 2, further comprising:

preventing charging of one of the first and the second batteries by the other one of the first and the second batteries.

6. The method of clause 2, wherein:

the first isolation section comprises a diode.

7. The method of clause 2, wherein the first battery comprises a rechargeable battery.

8. The method of clause 2, wherein:

the second battery comprises a thermal battery.

9. The method of clause 2, further comprising:

operating the first bus at an unloaded voltage lower than an unloaded voltage of the second bus.

10. The method of clause 2, further comprising:

operating the second bus at an unloaded voltage lower than an unloaded voltage of the first bus.

11. The method of clause 2, further comprising:

monitoring an electrical value of an electrical parameter on the external load bus; and

decoupling, using the first isolation section, the second battery from the external load bus responsive to the monitored electrical value and a threshold value of the electrical parameter.

12. The method of clause 11, further comprising:

providing the threshold value of the electrical parameter to the first isolation section.

13. The method of clause 11, wherein:

the electrical value comprises a current value on the external load bus; and

the threshold value comprises a first current threshold value.

14. The method of clause 11, wherein:

the decoupling comprises decoupling using an insulated gate bipolar transistor (IGBT).

15. The method of clause 11, wherein:

the electrical value comprises a power value on the external load bus; and

the threshold value comprises a first power threshold value.

16. The method of clause 11, wherein:

the decoupling the second battery further comprises decoupling the second battery using a time-delayed operation.

17. The method of clause 1, further comprising:

operating the first bus and the second bus at identical unloaded voltages; and

activating the second battery after an initial period of time during which only the first battery supplies power to the external load.

18. The method of clause 1, further comprising:

coupling, isolatably, the first bus to the second bus and the external load bus by an isolation section.

19. The method of clause 18, further comprising:

monitoring an electrical value of an electrical parameter on the external load bus; and

decoupling, using the isolation section, the first battery from the external load bus responsive to the monitored electrical value and a threshold value of the electrical parameter.

The subject technology is illustrated, for example, according to various aspects described below. Numbered clauses are provided below for convenience. These are provided as examples, and do not limit the subject technology.

1. An apparatus for supplying power to an external load, comprising:

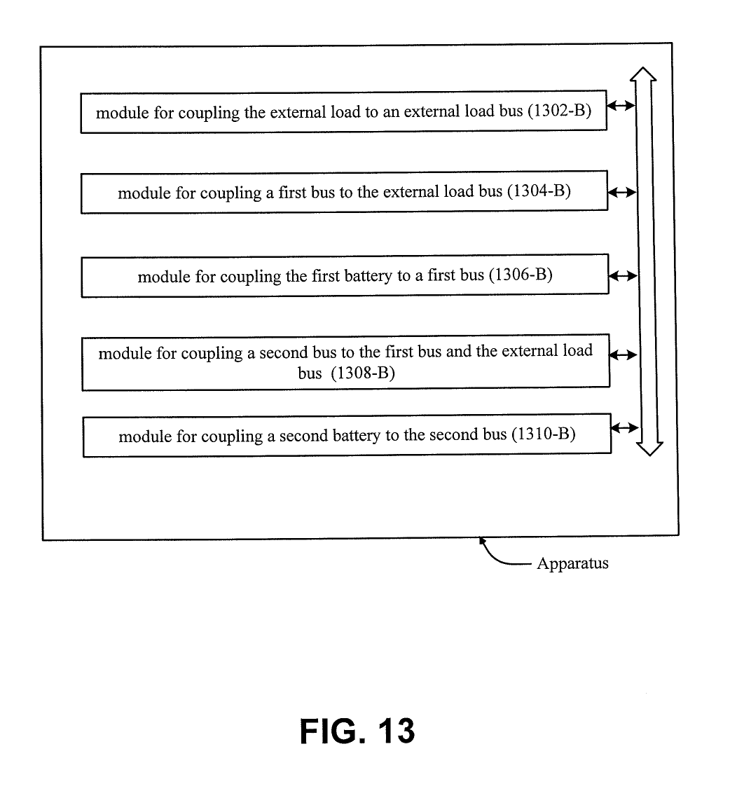

means for coupling the external load to an external load bus (e.g., 1302-B of FIG. 13);

means for coupling a first bus to the external load bus (e.g., 1304-B of FIG. 13);

means for coupling the first battery to a first bus (e.g., 1306-B of FIG. 13);

means for coupling a second bus to the first bus and the external load bus (e.g., 1308-B of FIG. 13); and

means for coupling a second battery to the second bus (e.g., 1310-B of FIG. 13);

wherein the second battery has a higher extracted specific power output value than the first battery and a faster energy transfer rate than the first battery.

2. The apparatus of clause 1, wherein:

the means for coupling the second bus comprises means for isolatably coupling the second bus to the first bus and the external load bus by a first isolation section.

3. The apparatus of clause 2, further comprising:

means for coupling, isolatably, the first bus to the second bus and the external load bus by a second isolation section.

4. The apparatus of clause 2, further comprising:

means for operating the first bus and the second bus at identical unloaded voltage.

5. The apparatus of clause 2, further comprising:

means for preventing charging of one of the first and the second batteries by the other one of the first and the second batteries.

6. The apparatus of clause 2, wherein:

the first isolation section comprises a diode.

7. The apparatus of clause 2, wherein:

the first battery comprises a rechargeable battery.

8. The apparatus of clause 2, wherein:

the second battery comprises a thermal battery.

9. The apparatus of clause 2, further comprising:

means for operating the first bus at an unloaded voltage lower than an unloaded voltage of the second bus.

10. The apparatus of clause 2, further comprising:

means for operating the second bus at an unloaded voltage lower than an unloaded voltage of the first bus.

11. The apparatus of clause 2, further comprising:

means for monitoring an electrical value of an electrical parameter on the external load bus; and

means for decoupling the second battery from the external load bus responsive to the monitored electrical value and a threshold value of the electrical parameter.

12. The apparatus of clause 11, further comprising:

means for providing a threshold value of an electrical parameter.

13. The apparatus of clause 11, wherein:

the electrical value comprises a current value on the external load bus; and

the threshold value comprises a first current threshold value.

14. The apparatus of clause 11, wherein:

means for the decoupling comprises decoupling using an insulated gate bipolar transistor (IGBT).

15. The apparatus of clause 11, wherein:

the electrical value comprises a power value on the external load bus; and

the threshold value comprises a first power threshold value.

16. The apparatus of clause 11, wherein:

means for the decoupling the second battery further comprises means for decoupling the second battery using a time-delayed operation.

17. The apparatus of clause 1, further comprising:

means for operating the first bus and the second bus at identical unloaded voltages; and

means for activating the second battery after an initial period of time during which only the first battery supplies power to the external load.

18. The apparatus of clause 1, further comprising:

means for coupling, isolatably, the first bus to the second bus and the external load bus by an isolation section.

19. The apparatus of clause 18, further comprising:

means for monitoring an electrical value of an electrical parameter on the external load bus; and

means for decoupling, using the isolation section, the first battery from the external load bus responsive to the monitored electrical value and a threshold value of the electrical parameter.

Those of skill in the art would appreciate that the various illustrative sections, modules, elements, components, methods, and operations described herein may be implemented as electronic hardware, computer software, or combinations of both. For example, sections 318, 314 or 312 may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various sections may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth parachart, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A hybrid electrical power system for supplying power to an external load, comprising:
an external load bus configured to be coupled to an external load;
a first bus coupled to the external load bus;
a first battery coupled to the first bus;
a second bus coupled to the first bus and the external load bus; and
a second battery coupled to the second bus;
wherein the second battery has a higher extracted specific power output value than the first battery and a faster energy transfer rate than the first battery.

2. The hybrid electrical power system of claim 1, wherein
the second bus is isolatably coupled to the first bus and the external load bus by a first isolation section.

3. The hybrid electrical power system of claim 2, wherein:
the first bus is isolatably coupled to the second bus and the external load bus by a second isolation section.

4. The hybrid electrical power system of claim 2, wherein:
the first bus and the second bus are configured to operate at an identical unloaded voltage.

5. The hybrid electrical power system of claim 2, wherein:
the first isolation section is configured to prevent charging of one of the first and the second batteries by the other one of the first and the second batteries.

6. The hybrid electrical power system of claim 2, wherein:
the first isolation section comprises a diode.

7. The hybrid electrical power system of claim 2, wherein:
the first battery comprises a rechargeable battery.

8. The hybrid electrical power system of claim 2, wherein:
the second battery comprises a thermal battery.

9. The hybrid electrical power system of claim 2, wherein:
the first bus is operated at an unloaded voltage lower than an unloaded voltage of the second bus.

10. The hybrid electrical power system of claim 2, wherein:
the second bus is configured to operate at an unloaded voltage lower than an unloaded voltage of the first bus.

11. The hybrid electrical power system of claim 2, further comprising:
a monitoring section configured to monitor an electrical value of an electrical parameter on the external load bus,
wherein the first isolation section configured to decouple the second battery from the external load bus responsive to the monitored electrical value and a threshold value of the electrical parameter.

12. The hybrid electrical power system of claim 11, further comprising:
a programmable threshold section configured to provide the threshold value of the electrical parameter to the first isolation section.

13. The hybrid electrical power system of claim 11, wherein:
the electrical value comprises a current value on the external load bus; and
the threshold value comprises a first current threshold value.

14. The hybrid electrical power system of claim 11 wherein:
the first isolation section comprises an insulated gate bipolar transistor (IGBT).

15. The hybrid electrical power system of claim 11, wherein:
the electrical value comprises a power value on the external load bus;
the threshold value comprises a first power threshold value.

16. The hybrid electrical power system of claim 11, wherein:
the first isolation section is configured to couple or decouple using a time-delayed operation.

17. The hybrid electrical power system of claim 1, wherein:
the first bus is isolatably coupled to the second bus and the external load bus by an isolation section.

18. The hybrid electrical power system of claim 17, further comprising:
a monitoring section configured to monitor an electrical value of an electrical parameter on the external load bus,
wherein the isolation section is configured to decouple or couple the first battery from the external load bus responsive to the monitored electrical value and a threshold value of the electrical parameter.

19. A method of supplying power to an external load, comprising:
coupling the external load to an external load bus;
coupling a first bus to the external load bus;
coupling the first battery to a first bus;
coupling a second bus to the first bus and the external load bus; and
coupling a second battery to the second bus;
wherein the second battery has a higher extracted specific power output value than the first battery and a faster energy transfer rate than the first battery.

20. The method of claim 19, wherein:
the coupling the second bus comprises coupling, isolatably, the second bus to the first bus and the external load bus by a first isolation section.

21. The method of claim 20, further comprising:
coupling, isolatably, the first bus to the second bus and the external load bus by a second isolation section.

22. The method of claim 20, further comprising:
operating the first bus and the second bus at identical unloaded voltage.

23. The method of claim 20, further comprising:
preventing charging of one of the first and the second batteries by the other one of the first and the second batteries.

24. The method of claim 20, wherein:
the first isolation section comprises a diode.

25. The method of claim 20, wherein the first battery comprises a rechargeable battery.

26. The method of claim 20, wherein:
the second battery comprises a thermal battery.

27. The method of claim 20, further comprising:
operating the first bus at an unloaded voltage lower than an unloaded voltage of the second bus.

28. The method of claim 20, further comprising:
operating the second bus at an unloaded voltage lower than an unloaded voltage of the first bus.

29. The method of claim 20, further comprising:
monitoring an electrical value of an electrical parameter on the external load bus; and
decoupling, using the first isolation section, the second battery from the external load bus responsive to the monitored electrical value and a threshold value of the electrical parameter.

30. The method of claim 29, further comprising:
providing the threshold value of the electrical parameter to the first isolation section.

31. The method of claim 29, wherein:
the electrical value comprises a current value on the external load bus; and
the threshold value comprises a first current threshold value.

32. The method of claim 29, wherein:
the decoupling comprises decoupling using an insulated gate bipolar transistor (IGBT).

33. The method of claim 29, wherein:
the electrical value comprises a power value on the external load bus; and
the threshold value comprises a first power threshold value.

34. The method of claim 29, wherein:
the decoupling the second battery further comprises decoupling the second battery using a time-delayed operation.

35. The method of claim 19, further comprising:
operating the first bus and the second bus at identical unloaded voltages; and
activating the second battery after an initial period of time during which only the first battery supplies power to the external load.

36. The method of claim 19, further comprising:
coupling, isolatably, the first bus to the second bus and the external load bus by an isolation section.

37. The method of claim 36, further comprising:
monitoring an electrical value of an electrical parameter on the external load bus; and
decoupling, using the isolation section, the first battery from the external load bus responsive to the monitored electrical value and a threshold value of the electrical parameter.

38. An apparatus for supplying power to an external load, comprising:
means for coupling the external load to an external load bus;
means for coupling a first bus to the external load bus;
means for coupling the first battery to a first bus;
means for coupling a second bus to the first bus and the external load bus; and
means for coupling a second battery to the second bus;
wherein the second battery has a higher extracted specific power output value than the first battery and a faster energy transfer rate than the first battery.

39. The apparatus of claim 38, wherein:
the means for coupling the second bus comprises means for isolatably coupling the second bus to the first bus and the external load bus by a first isolation section.

40. The apparatus of claim 39, further comprising:
means for coupling, isolatably, the first bus to the second bus and the external load bus by a second isolation section.

41. The apparatus of claim 39, further comprising:
means for operating the first bus and the second bus at identical unloaded voltage.

42. The apparatus of claim 39, further comprising:
means for preventing charging of one of the first and the second batteries by the other one of the first and the second batteries.

43. The apparatus of claim 39, wherein:
the first isolation section comprises a diode.

44. The apparatus of claim 39, wherein:
the first battery comprises a rechargeable battery.

45. The apparatus of claim 39, wherein:
the second battery comprises a thermal battery.

46. The apparatus of claim 39, further comprising:
means for operating the first bus at an unloaded voltage lower than an unloaded voltage of the second bus.

47. The apparatus of claim 39, further comprising:
means for operating the second bus at an unloaded voltage lower than an unloaded voltage of the first bus.

48. The apparatus of claim 39, further comprising:
means for monitoring an electrical value of an electrical parameter on the external load bus;
means for decoupling the second battery from the external load bus responsive to the monitored electrical value and a threshold value of the electrical parameter.

49. The apparatus of claim 48, further comprising:
means for providing a threshold value of an electrical parameter.

50. The apparatus of claim 48, wherein:
the electrical value comprises a current value on the external load bus; and
the threshold value comprises a first current threshold value.

51. The apparatus of claim 48, wherein:
means for the decoupling comprises decoupling using an insulated gate bipolar transistor (IGBT).

52. The apparatus of claim 48, wherein:
the electrical value comprises a power value on the external load bus; and
the threshold value comprises a first power threshold value.

53. The apparatus of claim 48, wherein:
means for the decoupling the second battery further comprises means for decoupling the second battery using a time-delayed operation.

54. The apparatus of claim 38, further comprising:
means for operating the first bus and the second bus at identical unloaded voltages; and
means for activating the second battery after an initial period of time during which only the first battery supplies power to the external load.

55. The apparatus of claim 38, further comprising:
means for coupling, isolatably, the first bus to the second bus and the external load bus by an isolation section.

56. The apparatus of claim 55, further comprising:
means for monitoring an electrical value of an electrical parameter on the external load bus; and
means for decoupling, using the isolation section, the first battery from the external load bus responsive to the monitored electrical value and a threshold value of the electrical parameter.
